(19) United States
(12) Patent Application Publication
(10) Pub. No.: US 2009/0256377 A1
(43) Pub. Date: Oct. 15, 2009

(54) MOVEABLE PET BARRIER

(76) Inventors: Kenneth L. Beechie, University Place, WA (US); Spring Serena Faussett, Kent, WA (US); Adam Michael Faussett, Kent, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 12/102,679

(22) Filed: Apr. 14, 2008

(51) Int. Cl. B60R 21/02; E06B 9/00

(52) U.S. Cl. 296/24.46; 49/58

(57) ABSTRACT

A barrier for partitioning sections of a vehicle includes a barrier portion and at least one attachment member adapted to secure the barrier portion to a vehicle seat. The barrier portion includes an upper center portion mateable with a lower center portion. The barrier portion further includes a first cross bar secured to the upper center portion, with the first cross bar having first and second ends, a second cross bar secured to the lower center portion, with the second cross bar having first and second ends, and a first connection member securable to the first ends of the first and second cross bars.

### BACKGROUND

Pets moving around freely in a vehicle are a safety hazard to themselves and to the passengers in the vehicle. For instance, if the pet is in the back seat of a vehicle, and the driver of the vehicle “slams on” the brakes, the pet could launch forward into the front seats and cause injury to the pet and/or to the driver. Moreover, if the pet climbs freely into the front seats of the vehicle, the pet will likely distract the driver and possibly cause an accident.

It is well known to install a pet barrier within a vehicle to separate two areas in a vehicle, such as a front row of seats and a back row of seats, or a back row of seats and a cargo area. In this manner, the animal can be transported in the vehicle without allowing the animal to climb freely between the two areas.

Many pet barriers are installed in a vehicle interior such that they extend from the floor to the ceiling of the vehicle to partition the animal transport area from the remainder of the vehicle. These pet barriers typically include spring-loaded elements that engage the floor and ceiling of the vehicle interior to secure the pet barrier therebetween. Thus, to properly secure the pet barrier between the floor and the ceiling, the pet barrier must be positioned substantially perpendicular between the floor and the ceiling. Moreover, the pet barrier is not moveable unless the spring-loaded elements are disengaged with the ceiling and floor and moved to another position.

Having a fixed pet barrier can cause problems when the driver or passenger needs to tilt or recline the seat or move the seat forward or backward. Thus, it is desired to have a pet barrier that suitably partitions a portion of a vehicle interior without interfering with the movement of the vehicle seats.

### SUMMARY

A barrier for partitioning seats in a vehicle includes a barrier portion and at least one attachment member adapted to secure the barrier portion to a vehicle seat. The barrier portion includes an upper center portion mateable with a lower center portion. The barrier portion further includes a first cross bar secured to the upper center portion, with the first cross bar having first and second ends, a second cross bar secured to the lower center portion, with the second cross bar having first and second ends, and a first connection member securable to the first ends of the first and second cross bars.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of the present disclosure will become more readily appreciated by reference to the following detailed description, when taken in conjunction with the accompanying drawings, wherein:

FIG. 1 is an environmental view of a representative embodiment of the moveable pet barrier, wherein the pet barrier is secured to a row of seats within an interior of a vehicle;

FIG. 2 is an isometric view of the barrier portion of the moveable pet barrier of FIG. 1;

FIG. 3 is a partial exploded view of the barrier portion of FIG. 2;

FIG. 4 is a partial exploded view of the barrier portion of FIG. 2, wherein a plurality of cross bars are being bent to receive U-shaped members thereon;

FIG. 5 is a side view of the pet barrier of FIG. 1, wherein at least a portion of the row of seats is being moved between first and second positions; and

FIG. 6 is a side view of the pet barrier of FIG. 1, wherein at least a portion of the row of seats is being moved between third and fourth positions.

### DETAILED DESCRIPTION

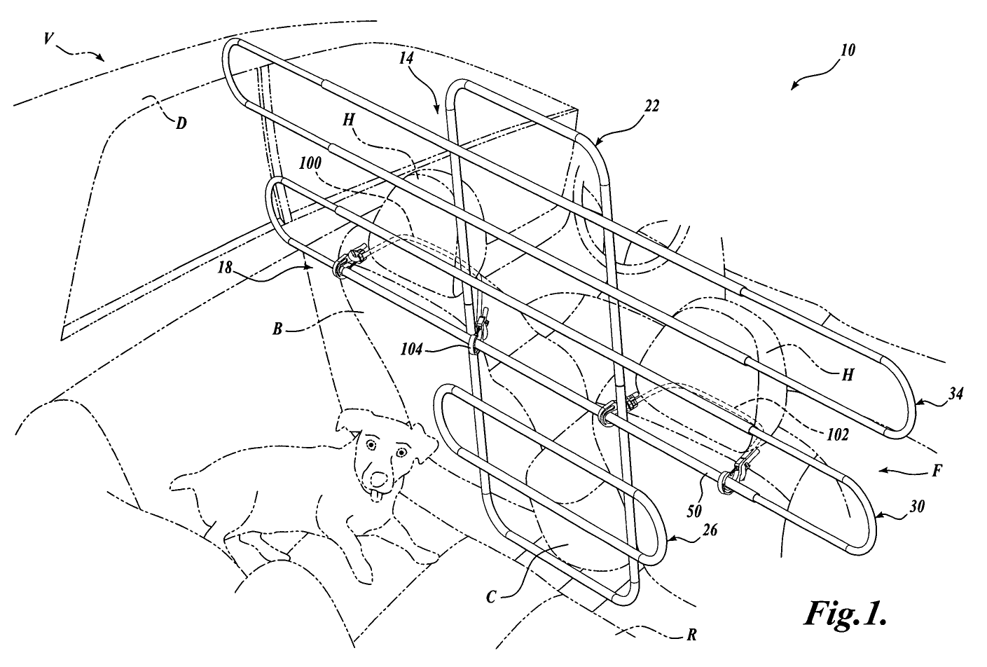

A moveable pet barrier 10 constructed in accordance with one embodiment of the present disclosure is best seen by referring to FIG. 1. The pet barrier 10 is used to partition first and second areas of a vehicle V such that an animal positioned in one of the areas can travel within the vehicle without being able to move freely between the first and second areas of the vehicle. The pet barrier may be used in any suitable vehicle V having a row of seats and an area behind the row of seats, such as a second row of seats or a cargo space. The vehicle depicted in FIG. 1 is an example of a suitable vehicle that can be partitioned by the pet barrier 10, and it includes front seats F and rear seats R positioned behind the front row of seats F. Each of the front seats F includes a seatback B and a headrest H secured to an upper portion of the seatback B. It should be appreciated that the pet barrier 10 may instead be used to partition any other suitable vehicle or area.

The pet barrier 10 includes a barrier portion 14 that is configured to separate the first and second areas of a vehicle, such as the front seats F and the rear seats R. The pet barrier 10 further includes an attachment assembly 18 for securing the barrier portion 14 to a portion of the vehicle, such as the seatback B or the headrest H.

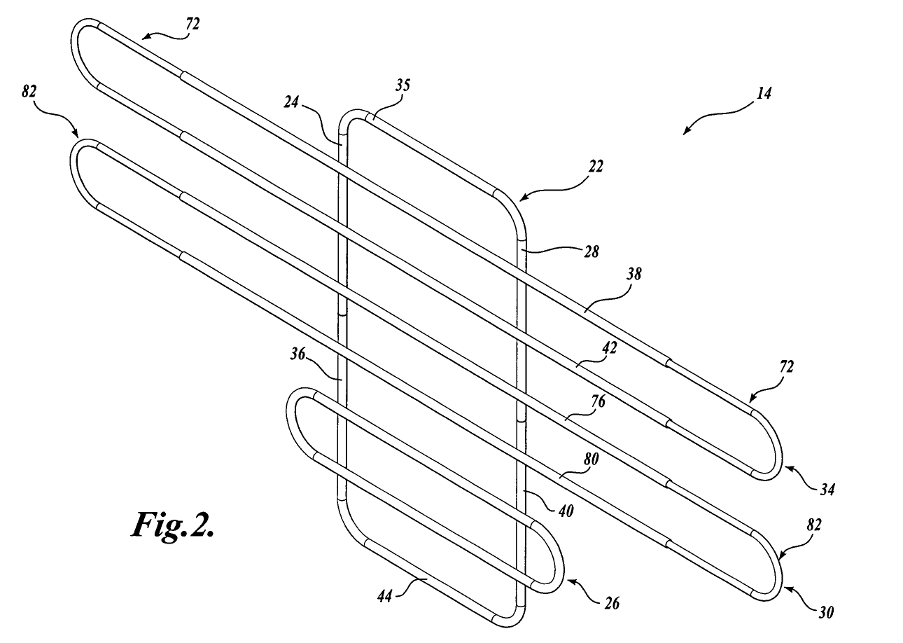

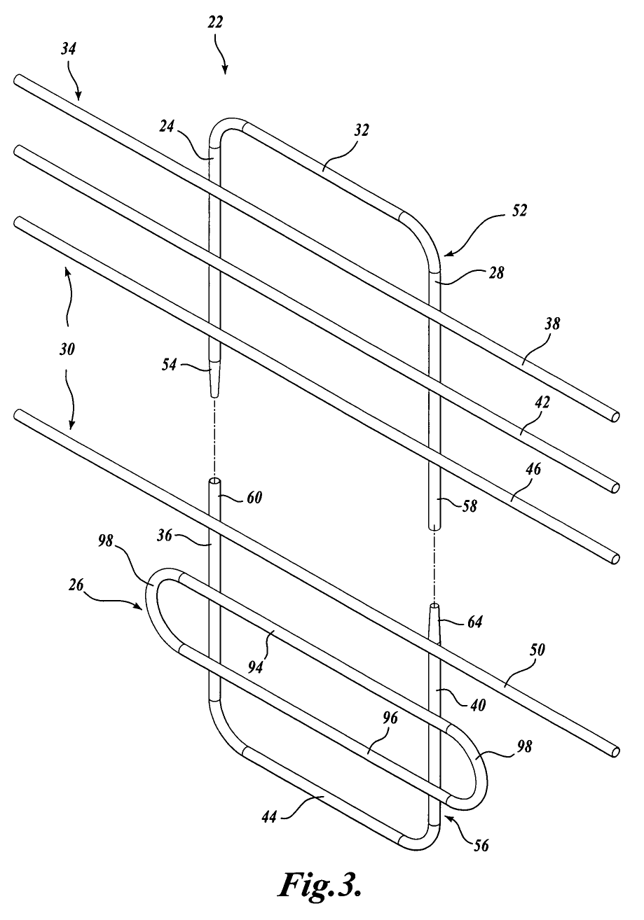

Referring additionally to FIGS. 2 and 3, the barrier portion 14 of the pet barrier 10 will now be described in detail. The barrier portion 14 is formed from several sections of tubing, such as steel, aluminum, or another type of metal tubing, or any other type of material that is durable and lightweight, such as a high quality plastic material. The barrier portion 14 includes a center upright section 22 that is defined by an upper center portion 52 and a lower center portion 56 that are securable together to form a substantially rectangular configuration.

The upper center portion 52 includes first and second substantially parallel upper side members 24 and 28 and a substantially transverse upper member 32 extending between and connecting the upper ends of the first and second upper side members 24 and 28. The corners defined by the intersection of the first and second upper vertical members 24 and 28 and the upper transverse member 32 may be curved to provide a more contoured design. The lower center portion 56 substantially mirrors the upper center portion 52 and is defined by parallel first and second lower side members 36 and 40 and a lower transverse member 44 extending therebetween.

To secure the upper and lower center portions 52 and 56 together, the first and second ends 54 and 58 of the first and second upper side members 24 and 28 of the upper center portion 52 are positioned to engage the first and second ends 60 and 64 of the first and second lower side members 36 and 40 of the lower center portion 56. Although the upper center portion 52 may be secured to the lower center portion 56 in any suitable manner, the first and second ends 54 and 58 of the upper center portion 52 are preferably frictionally engaged with the first and second ends 60 and 64 of the lower center portion 56.

To accomplish a friction fit, the first end 54 of the upper center portion 52 is preferably swaged, and the second end 64 of the lower center portion 56 is swaged. The first and second swaged ends 54 and 64 are of a diameter such that they are adapted to be frictionally received within first and second ends 60 and 58, respectively. In this manner, the upper center portion 52 is not easily separated from the lower center portion 56. It should be appreciated that the first and second ends 60 and 58 may instead be swaged and adapted to be received within the first and second ends 54 and 64, respectively. The first and second ends 54 and 60 and 58 and 64 may further include a pushbutton assembly (not shown) or other mechanism defined between the ends to additionally secure the upper center portion 52 to the lower center portion 56.

Moreover, with the upper and lower center portions 52 and 56 each including a swaged end 54 and 64 that is receivable only within one opposing end (60 and 58, respectively) of the other of the upper or lower center portion 52 or 56, the upper and lower center portions 52 and 56 must be arranged in a specific manner when the barrier portion 14 is assembled. For instance, the upper and lower center portions 52 and 56 must be assembled to both face the same direction (e.g. with the upper, middle, and lower cross sections 34, 30, and 26 mounted on the same side of the center vertical section 22). However, it should be appreciated that the upper center portion 52 may instead include first and second ends 54 and 58 that are adapted to be engaged with either of the first and second ends 60 and 64 of the lower center portion 56. In this manner, the upper and lower center portions 52 and 56 may be arranged any suitable manner when the barrier portion 14 is assembled.

Referring to FIGS. 2 and 3, the barrier portion 14 further includes an upper cross section 34, a middle cross section 30, and a lower cross section 26 secured to the center upright section 22 in any suitable manner, such as by welding. The upper cross section 34 is defined by a first upper crossbar 38 mounted to the first and second upper side members 24 and 28 of the upper center portion 52. The first upper crossbar 38 is mounted to the first and second upper side members 24 and 28 such that it is substantially transverse to the longitudinal axes of the first and second side members 24 and 28. The upper cross section 34 further includes a first lower crossbar 42 secured to the first and second upper side members 24 and 28 in a spaced parallel relationship to the first upper crossbar 38.

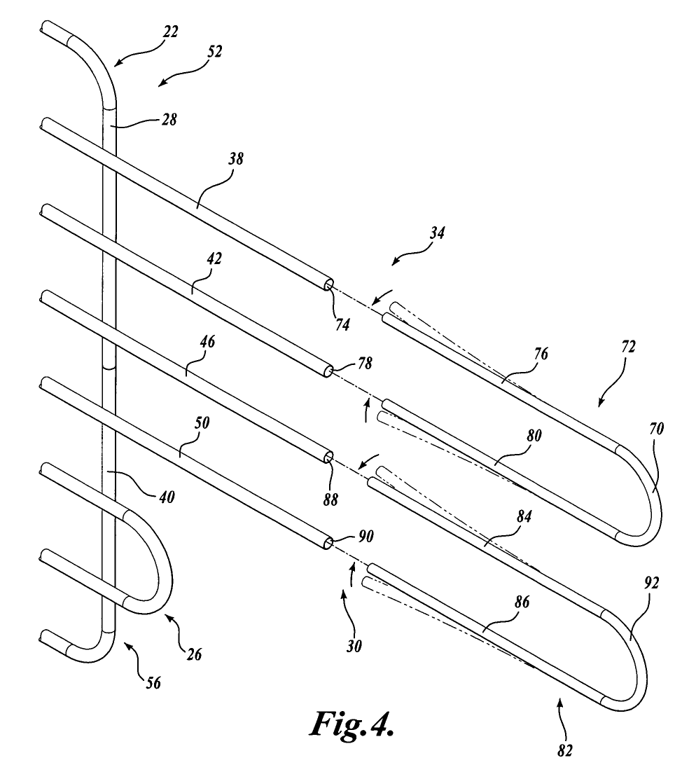

Referring also to FIG. 4, portions of the first upper and lower crossbars 38 and 42 extend laterally from the first and second upper side members 24 and 28 and include end openings for receiving the ends of a first connection member, or slide element 72 therein. The first slide element 72 is preferably substantially U-shaped and is defined by a first upper slide bar 76, a first lower slide bar 80, and a first U-shaped end portion 70 extending therebetween to position the first upper and lower slide bars 76 and 80 in a spaced parallel relationship. The first upper slide bar 76 is receivable within the end opening 74 of the first upper crossbar 38 and the first lower slide bar 80 is receivable within the end opening 78 of the first lower crossbar 42.

The first upper and lower slide bars 76 and 80 are slidably and frictionally received within the end openings 74 and 78 to prevent the first slide element 72 from being easily removed when the pet barrier 10 is assembled. To achieve a friction fit, the first upper and lower slide bars 76 and 80 may be bent slightly outwardly from each other when they are formed such that when a user is assembling the pet barrier 10, the first upper and lower slide bars 76 and 80 must be bent towards each other to be received within the end openings 74 and 78 of the first upper and lower crossbars 38 and 42. In the alternative, the first upper and lower crossbars 38 and 42 may instead be formed with a slight bend such that they must be bent towards each other to frictionally receive the first upper and lower slide bars 76 and 80.

With the first upper and lower slide bars 76 and 80 being urged in opposite directions, the first upper and lower slide bars 76 and 80 are frictionally received within the first upper and lower crossbars 38 and 42 such that the slide element 72 is maintained within the first upper and lower crossbars 38 and 42. However, the friction fit is not so tight such the first upper and lower slide bars 76 and 80 may not slide within the first upper and lower crossbars 38 and 42. As such, the slide element 72 may be moved within the first upper and lower crossbars 38 and 42 to adjust the width of the upper cross section 34. Moreover, a slide element 72 may be received within each end of the first upper and lower crossbars 38 and 42 to adjust the width of the upper horizontal section 34 in two directions. It should be appreciated that the pet barrier 10 may include any other suitable design for adjusting the width of the upper horizontal section 34 or another portion of the pet barrier 10.

Referring again to FIGS. 2 and 3, the middle cross section 30 is constructed substantially identical to the upper horizontal portion 34. The middle horizontal portion 30 includes a second upper crossbar 46 secured to the first and second upper side members 24 and 28 of the upper center portion 52. The second upper crossbar 46 is mounted to the first and second upper side members 24 and 28 such that it is substantially transverse to the longitudinal axes of the first and second upper side members 24 and 28 and in a spaced parallel relationship to the first upper and lower slide bars 76 and 80. A second lower crossbar 50 is secured to the first and second lower side members 36 and 40 such that it is substantially transverse to the longitudinal axes of the first and second lower side members 36 and 40. In this manner, the second lower crossbar 50 is positioned substantially parallel to the second upper crossbar 46 when the upper center portion 52 is mated with the lower center portion 56 as described above.

When the upper and lower center portions 52 and 56 are assembled together, the ends of the second upper and lower crossbars 46 and 50 are adapted to slidably receive a second substantially U-shaped slide element 82 therein. The second U-shaped slide element 82 is similar to the first U-shaped slide element 72 in that it has a second upper slide bar 84, a second lower slide bar 86, and a U-shaped end portion 92 extending therebetween to position the upper and lower slide bars 84 and 86 in a spaced parallel relationship. The second U-shaped slide element 82 is slidably and frictionally received within end openings 88 and 90 of the second upper and lower crossbars 46 and 50 in a substantially similar manner that the first slide element 72 is received within end openings 74 and 78 of the first upper and lower crossbars 38 and 42. Therefore, the manner in which the second slide element 82 is slidably and frictionally received within the second upper and lower crossbars 46 and 50 will not be hereinafter described in detail.

The second U-shaped slide element 82 secures the second upper slide bar 84 to the second lower slide bar 86 to define the middle cross section 30. As discussed above, the middle cross section 30 is secured to the center upright section 22, and the center upright section 22 is defined by an upper center section 52 mated to a lower center section 56. The second upper crossbar 46 of the middle cross section 30 is secured to the upper center section 52, and the second lower crossbar 50 of the middle cross section 30 is secured to the lower center section 56. Accordingly, the second U-shaped slide element 82 helps secure the lower center section 56 to the upper center section 52.

Referring to FIG. 3, the lower cross section portion 26 is substantially similar to the upper and middle cross sections 34 and 30 except that the lower cross section 26 is preferably formed as an integral structure. The lower cross section 26 is defined by third upper and lower crossbars 94 and 96 and curved end portions 98. The third upper and lower crossbars 94 and 96 are secured to the first and second lower vertical members 36 and 40 in a spaced parallel relationship to each other and substantially transverse to the longitudinal axes of the first and second lower vertical members 36 and 40. It should be appreciated that the lower horizontal section may instead include slide elements receivable within the ends of the third upper and lower crossbars 94 and 96 similar to the middle and upper cross sections 30 and 34.

The upper, middle, and lower cross sections 34, 30, and 26 are arranged on the center section 22 to suitably partition first and second areas of a vehicle. It should be appreciated that the upper, middle, and lower cross sections 34, 30, and 26, may be any suitable shape and may be arranged on the center section 22 in any suitable manner to adequately partition the first and second areas of the vehicle.

Referring back to FIG. 1, the barrier portion 14 is secured within the vehicle to separate the front seats F from the rear seats R. The barrier portion 14 is positioned against the backs B of the front seats F in any suitable, desired position. Preferably, the barrier portion 14 is positioned against the backs B of the front seats F such that the center vertical section 22 is substantially centered width-wise within the vehicle interior. The vertical position of the barrier portion 14 is adjusted to suitably partition the front and rear seats F and R. The lower cross section 26 is preferably positioned against a bottom portion of the seat backs B, and/or a center console C disposed between the front seats F, and the middle cross section 30 is positioned against an upper portion of the seat backs B and/or the seat headrests H. The upper cross section 34 may be positioned against a portion of the headrests H or may instead be disposed between the headrests H and the ceiling of the vehicle. If the pet barrier 10 is being used within a larger vehicle, such as a van, truck, recreational vehicle, etc., an additional section (not shown) similar in shape and design to the center section 22 and having a cross section secured thereto that is similar in shape and design to the lower cross section 26 may be secured to the barrier portion 14 to increase the overall height of the barrier portion 14. Any suitable section may be used, and it may be secured to the barrier portion in any suitable manner. For instance, the barrier portion 14 may include tapped holes drilled within the lower center section 56 that are adapted to receive fasteners, such as screws, to couple the additional section to the barrier portion 14.

The width of the barrier portion 14 may also be adjusted to ensure adequate separation of the front and rear seats F and R. The width of the barrier portion 14 is adjusted through the use of the first and second sliding elements 72 and 84 as described above. The width can be adjusted until the barrier portion 14 extends across a majority or substantially all of the vehicle interior to adequately partition the front and rear seats F and R.

With the barrier portion 14 positioned within the vehicle as described above, the barrier portion 14 extends across substantially all open areas defined between the front and rear seats F and R. More specifically, the lower, middle, and upper cross sections 26, 30 and 34 extend across at least a portion of any gap defined between the front seats F. The middle and upper cross sections 30 and 34 extend across at least a portion of any gap defined between the front seats F and the interior of the vehicle doors D (only one door shown for clarity). Moreover, the upper cross section 34, and possibly a portion of the middle cross section 30, is positioned between the headrests H and the ceiling of the vehicle. As such, the barrier portion 14 substantially separates the front seats F from the rear seats R.

The barrier portion 14 is secured to the front seats F through the attachment assembly 18. The attachment assembly 18 may be any suitable assembly that is adapted to secure the barrier portion 14 to the seat backs B or the head rests H of the front seats F. A preferred attachment assembly 18 includes first and second cords 100 and 102 that are preferably made at least in part from an elastic material that is stretchable like a bungee cord. Any suitable rope or cable, stretchable or non-stretchable, may instead be used. A hook 104 is secured to each end of the cords 100 and 102 for securing the cord ends to a section of tubing on the barrier portion 14. The hooks 104 are preferably adjustably secured to the ends of each cord 100 and 102 such that the cords 100 and 102 may be adjusted in length to accommodate various attachment locations on the front seats F. It should be appreciated that only one hook may instead be used, with the open end of the cord being tied or otherwise attached to the barrier portion 14 or the front seats F.

To secure the barrier portion 14 to the front seats F, the first cord 100 is passed around a portion of one of the front seats F, such as a backrest B or a headrest H, and the hooks 104 on each end of the first cord 100 are secured to the barrier portion 14. Depending on whether the first cord 100 is passed around the seatback B or the head rest H, the first cord 100 may first be adjusted in length such that the first cord 100 fits snugly around the seatback B or the head rest H. FIG. 1 depicts the first cord 100 passing around one of the headrests H with each hook 104 secured to the second lower cross bar 50 of the middle horizontal section 30. It should be appreciated that the hooks 104 may instead be secured on any other section of the barrier portion 14. The second strap 102 is used to secure a second section of the barrier portion 14 to the other headrest H in the same manner.

Referring to FIGS. 1, 5, and 6, with the barrier portion 14 positioned against the seat backs B in the manner described above, and with the cords 100 attaching the second lower cross bar 50 of the barrier portion 14 to the headrests H, the barrier portion 14 can pivot about the horizontal axis defined by the second lower cross bar 50. Moreover, with the first upper cross section 34 and a majority of the middle cross section 30 positioned above the pivot axis (the second lower cross bar 50), the majority of the weight of the barrier portion 14 is above the pivot axis. As such, the barrier portion 14 pivots away form the headrests H and towards the seat backs B and console C when the seat backs B are slightly tilted toward the rear seats R. In this manner, the barrier portion 14 is held firmly against the seat backs B. It should be appreciated that the barrier portion 14 may instead be “top heavy” by adding weight to the upper barrier portion 14 and thereafter positioning the barrier portion 14 against the seat backs B in any other suitable manner.

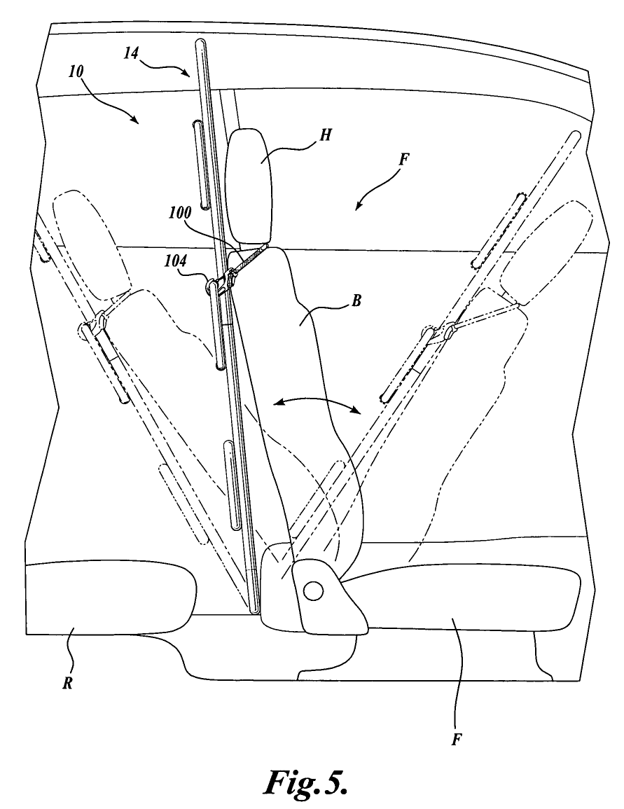

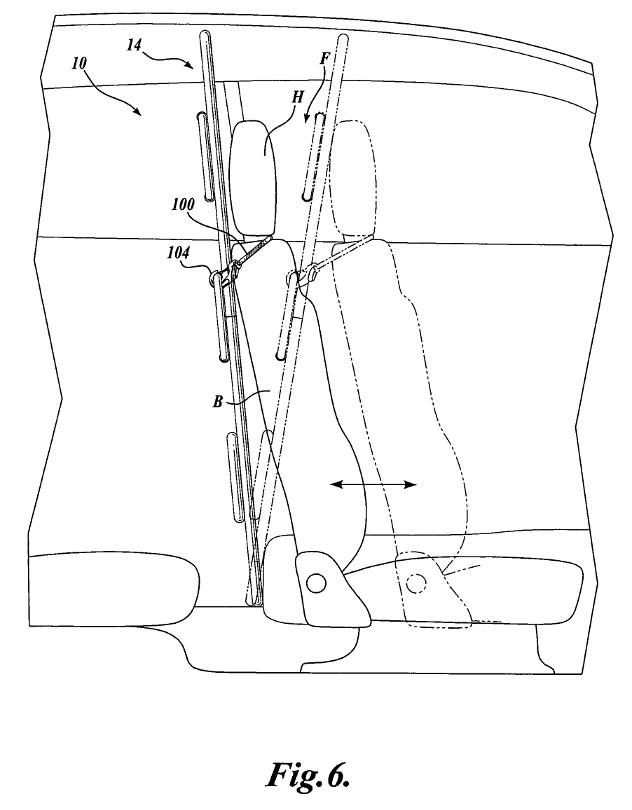

Referring to FIGS. 5 and 6, the barrier portion 14 is secured to the headrests H or the seatbacks B in a manner that allows either one of the front seats F to move substantially uninhibited by the barrier portion 14. As shown in FIG. 5, the seatbacks B can recline and rotate forward while the barrier portion 14 is positioned against the seatback B and secured to the headrest H. If the first cord 100 is elastic, the first cord 100 can stretch to allow the barrier portion 14 to adjust in position against the front seats F when the seatback B is moved. Similarly, either one of the front seats F can tilt or slide forward and rearward while having the barrier portion 14 secured thereto, as shown in FIGS. 5 and 6. As such, the pet barrier 10 does not need to be moved or removed from its position when the driver or passenger wishes to move the front seats F.

While illustrative embodiments have been illustrated and described, it will be appreciated that various changes can be made therein without departing from the spirit and scope of the present disclosure. For instance, the pet barrier 10 may instead be used to partition any other suitable area of a car or an area of a building, such as a stairway. The straps 100 and 102 can be passed around any suitable support structure to position the barrier portion 14 in a desired location. Moreover, the pet barrier 10 may instead be used to isolate an area from children. Also, a larger or fewer number of cross sections similar to cross sections 26, 30, and 34 can be utilized depending on various factors, such as the size of the vehicle and/or size of the pet(s) or other things or items sought to be isolated. Thus, it should be appreciated that the foregoing description of the pet barrier 10 should not be seen as limiting the claimed subject matter.

The embodiments of the present disclosure in which an exclusive property or privilege is claimed are defined as follows:

1. A barrier for partitioning sections of a vehicle having seats, comprising:
(a) a barrier portion, comprising:
(i) an upper center portion mateable with a lower center portion;
(ii) a first cross bar secured to the upper center portion, the first cross bar having first and second ends;
(iii) a second cross bar secured to the lower center portion; the second cross bar having first and second ends;
(iv) a first connection member securable to the first ends of both the first and second cross bars; and
(b) at least one attachment member adapted to secure the barrier portion to a vehicle seat.

2. The barrier of claim 1, wherein the first connection member is substantially U-shaped and defines first and second slide bars, wherein the first and second slide bars of the first connection member are slidably engageable with the first ends of the first and second cross bars.

3. The barrier of claim 2, wherein the first connection member secures the upper center portion to the lower center portion when the first connection member is engaged with the first ends of the first and second cross bars.

4. The barrier of claim 2, wherein the first and second slide bars are urged in opposite directions relative to each other when the first connection member is engaged with the first and second cross bars.

5. The barrier of claim 1, further comprising a second connection member securable to the second ends of the first and second cross bars.

6. The barrier of claim 1, wherein the at least one attachment member is a strap having a first and second ends.

7. The barrier of claim 6, wherein the barrier portion is secured to the vehicle seat by passing the strap around a portion of the vehicle seat, and by securing the first and second ends of the strap to the barrier portion.

8. The barrier of claim 6, wherein first and second hooks are adjustably secured on the first and second ends of the strap.

9. The barrier of claim 1, further comprising third and fourth cross bars secured to the upper center portion, the third and fourth cross bars having first and second ends.

10. The barrier of claim 1, further comprising a third connection member securable with the first ends of the third and fourth cross bars, and a fourth connection member securable with the second ends of the third and fourth cross bars.

11. The barrier of claim 1, wherein the upper center portion is mateable with the lower center portion in a predetermine manner.

12. The barrier of claim 11, wherein the upper center portion includes first and second ends that frictionally engage first and second ends of the lower center portion.

13. A barrier for partitioning sections of a vehicle having seats, the barrier comprising:
(a) a barrier portion, comprising:
(i) an upper center portion mateable with a lower center portion;
(ii) a first cross bar secured to the upper center portion, the first cross bar having first and second ends;
(iii) a second cross bar secured to the lower center portion; the second cross bar having first and second ends;
(iv) a first connection member securable to the first ends of the first and second cross bars;
(v) a second connection member securable to the second ends of the first and second cross bars;
(b) at least one attachment member adapted to secure the barrier portion to the vehicle seats such that the seats may be moved between first and second positions.

14. The barrier of claim 13, wherein the first connection member is generally U-shaped and defines first and second slide bars, wherein the first and second slide bars of the first connection member are slidably engageable with the first ends of the first and second cross bars.

15. The barrier of claim 14, wherein the first connection member secures the upper center portion to the lower center portion when the first connection member is engaged with the first ends of the first and second cross bars.

16. The barrier of claim 14, wherein the first and second slide bars are urged in opposite relative directions when the first connection member is engaged with the first ends of the first and second cross bars.

17. The barrier of claim 13, wherein the at least one attachment member is a strap having a first and second ends.

18. The barrier of claim 17, wherein the barrier portion is securable to the vehicle seat by passing the strap around a portion of at least one of the seats, and by securing the first and second ends of the strap to the barrier portion.

19. The barrier of claim 13, wherein the upper center portion is mateable with the lower center portion in a predetermine manner.

20. The barrier of claim 19, wherein the upper center portion includes first and second ends that frictionally engage first and second ends of the lower center portion.
